(19) United States
(12) Patent Application Publication
(10) Pub. No.: US 2010/0154669 A1
(43) Pub. Date: Jun. 24, 2010

(54) PROCESS FOR PRINTING AND COATING, AND APPARATUS IMPLEMENTING THE PROCESS

(76) Inventor: Ghislain Ambrosius Marcel Borremans, Veltem Beisem (BE)

Correspondence Address: BACON & THOMAS, PLLC, 625 SLATERS LANE, FOURTH FLOOR, ALEXANDRIA, VA, 22314-1176, US

(21) Appl. No.: 12/303,748

(22) PCT Filed: May 30, 2007
(86) PCT No.: PCT/EP2007/055258

§ 371 Date: Jan. 22, 2009

(30) Foreign Application Priority Data
Jun. 16, 2006 (EP) 06012386.6

(51) Int. Cl. B41L 35/14

(52) U.S. Cl. 101/488; 101/424.2

(57) ABSTRACT

To print and coat a medium (111), an image is printed on the medium (111), the printed medium (112) is inline dried, and the dried printed medium is inline coated. Both the drying and coating processes operate in synchronism with the printing process.

### FIELD OF THE INVENTION

The present invention generally relates to printing on a medium or substrate, e.g. through ejection of ink droplets in an ink jet process, and coating of the printed medium or substrate. The coating generally improves the image quality, weather or moisture resistance of the image, resistance to fading, and it avoids deterioration of the image for instance through UV light, scratches, etc.

### BACKGROUND OF THE INVENTION

To produce high quality images that resist certain conditions such as moisture, heat, etc. either printing/laminating or printing/coating processes are described in literature and commercial products are available implementing such processes.

Printing/laminating processes have as drawback that the laminating process is inevitably applied to the entire recording medium for the width of the laminating member. Furthermore, the laminating member and the printed medium need to be aligned, and laminating requires the presence of a laminate member feeding roller, often a heater and related mechanics, rendering the image forming apparatus rather bulky and complex.

US Patent Application No. 2002/0118987 A1 for instance describes an image forming apparatus (100 in FIG. 1) having a recording portion (20 in FIG. 1) and a laminating portion (70 in FIG. 1). The recording portion discharges ink from one or plural ink jet recording heads (1 in FIG. 1) for recording an image on a recording medium. The laminating portion applies a laminate material onto the recording medium. After the image recording, the leading edge of the paper or recording medium is detected by a sensor (79 in FIG. 4), and the recording medium is passed through a pair of heated rollers (71A, 718 in FIG. 1) in the laminating portion in order to dry the recording medium and prevent that moisture gets trapped between the recording medium and the laminate layer. After the drying step, a pair of heated pressurizing rollers (72A, 72B) applies a laminate film on the recording medium.

The drying process in US 2002/0118987 A1 copes with a problem that is specific to laminating, i.e. the presence of air pockets or bubbles in between the laminate and medium. In addition to suffering from the typical shortcomings inherent to laminating, the drying process executed in between the recording and laminating in US 2002/0118987 A1 is not synchronized with the recording process. Further, the drying is applied to the entire recording medium, which is not efficient in terms of energy consumption.

Some of the drawbacks inherently associated with printing/laminating processes, are overcome by printing/coating processes wherein the printed or recorded medium is protected through a varnish or variant coating material that is sprayed onto portions of the medium that have been printed.

Such an integrated printing/coating process is described for example in Japanese Patent Application JP61047284. Therein, a uniform thin coating is provided over the surface of recorded paper. The spray apparatus that applies the coating follows the operation of the printing head in such a way that the coating is performed slightly delayed relative to the movement of the printing head, enabling adherence of the ink droplets to the recording paper. However, since the coating is only slightly delayed vis-à-vis the printing, the ink droplets may be insufficiently dry when the coating is applied, as a consequence of which the interaction between coating and ink droplets may result in deterioration of the image.

The just mentioned shortcoming related to the process described in Japanese Patent Application JP61047284 may be overcome by the process described in German Patent Application DE 100 51 088 A1. In the single-stage process disclosed therein, a surface is printed and the printed surface is covered by a sprayed varnish. Optionally, a primer is sprayed onto the surface before the image is printed. To avoid impact between the printing and varnishing (or coating) the printing process uses oil, ultra violet or solvent inks, and a time interval of preferably 4 minutes, but realistically up to 10 minutes is respected between the printing step and coating step. The process disclosed in DE 100 51 088 A1 however is slow and plagued by undue restrictions such as the choice of certain inks. In particular when the surface is sprayed with a primer before the image is printed, it can take up to 20 minutes to print and coat a single image according to the process of DE 100 51 088 A1.

A variant prior art solution for creating photographic quality prints is described in US Patent Application 2003/0013033. According to the method disclosed therein, an image is reverse printed on a transparent substrate through ink jet, electrostatic or other printing methods. Thereafter, a particle-based undercoat layer is coated onto the printed substrate during an in-line process rather than a separate offline step. The particle-based undercoat serves as a solid-filled, reflective background for the image. In certain embodiments, the transparent carrier is pre-heated to facilitate adhesion of the undercoat layer to the transparent medium.

The reverse technique disclosed in US 2003/0013033 requires good adhesion between the ink and the transparent substrate, and usually relies on a process called fusing to affix the particle-based undercoat to the transparent carrier. The pre-heating must be applied to the entire surface and is typically realized by a conductive heater under the transparent carrier or a radiant heater above the carrier surface. The heating is not synchronized or aligned with the printing process.

It is an object of the present invention to provide a process for printing and coating that overcomes the various drawbacks of the prior art solutions described above. In particular, it is an object to enable inline printing/coating in a timely fashion without the risk of deteriorating the image through impact between the printing ink and coating material, and without a need for additional processes like fusing. Further, it is an object to efficiently consume and where possible reduce energy consumption.

### SUMMARY OF THE INVENTION

According to the invention, the above defined object is realized by a process for printing and coating of a medium as defined by claim 1, comprising the steps of:
a. printing an image on the medium, thereby generating a printed medium;
b. inline drying the printed medium in synchronism with the printing in step a, thereby generating a dried printed medium; and
c. inline coating the dried printed medium in synchronism with the printing in step a, thereby generating a coated printed medium.

Indeed, through active inline drying in synchronism with the printing, the amount of time required in between printing and coating to avoid interaction between the ink and coating material is reduced significantly. Further, through inline coating in synchronism with the printing step, the movements of the coating device are in sync with the movements of the printing device, and the coating device is controlled in such a way that no coating material is sprayed onto the medium while the medium is progressed. Thanks to this synchronism, the coating device needs no medium drive mechanism of its own, and the entire process of printing and coating is automated in a single cycle. Consequently, the current invention adds to reduce the process and hardware complexity.

In addition to the process defined by claim 1, the current invention relates to a corresponding apparatus for printing and coating as defined by claim 7, comprising:
a. a printing device for printing an image on a medium to thereby generate a printed medium;
b. an inline drying device for drying at least portions of the printed medium to thereby generate a dried printed medium, the inline drying device being adapted to operate in synchronism with the printing device; and
c. an inline coating device for coating at least portions of the dried printed medium to thereby generate a coated printed medium, the inline coating device being adapted to operate in synchronism with the printing device.

An optional feature of respectively the process and apparatus according to the current invention, defined by claims 2 and 8, is that the current invention further may comprise inline drying the coated printed medium in synchronism with the printing in step a.

This way, the risk for deterioration of the coated printed medium is further reduced by accelerating the drying process for the coating material through active post-drying.

The active post-drying may be realised through heated surfacing, ventilation, radiation, UV (ultraviolet) treatment, etc. or through combination of such techniques.

A further optional feature of the present invention, defined by claim 3, is that the drying in step b and/or the drying in step d are executed only on portions of the medium that are coated in said step c.

By restriction of the active drying before and eventually after the coating step to portions of the medium that have been printed, the power consumption and consequently the operational cost of printing and coating get reduced. The drying can be reduced to coated portions only for instance by rigidly mounting the drying device(s) and the coating device on a single carriage, movable mounted along a bridge. This way, the drying device(s) move only in zones where the coating material is sprayed.

Another optional feature of the present invention is that the drying in step b and/or the drying in step d involve ventilation and/or heated surfacing. This optional feature is defined by claim 4.

Indeed, although various alternate techniques can be considered for the drying before and eventually after the coating, a combination of active ventilation and heated surfacing is preferred. The active ventilation may be implemented through one or more relatively small ventilator(s) fixedly mounted onto or attached to the coating device. The surface heating can be realised through heating the surface over which the medium is moved towards the coating device via a conductive resistor underneath the surface.

Yet another optional characteristic of the present invention, is that the inline coating in step c is synchronized with the printing in step a through signalling received from the printing process in step a. This optional element is defined by claim 5.

Thus, one way to synchronize the coating with the printing is through signalling received from the printing device. The signalling may be indicative for the start and stop of the movement of the print head printing successive lines of an image. As an alternative to the signalling, the coating device may be deployed in conjunction with a sensor that senses advancement of the medium and prevents the coating device from applying coating material while the medium is being advanced. Another alternative is a sensor in the printing device that senses the start and stop of the print head. Yet another option is pre-configuration of the coating step preventing the coating material to be applied when the medium is progressed through the printing apparatus.

Still an option of the printing process according to the present invention is that the inline coating in step c is executed on portions of the medium identified by signalling received from the printing process in step a. This optional feature is defined by claim 6.

Indeed, in addition to signalling the start and stop of the movement of the print head, electronic signalling between the printing device and coating device may be indicative for the portions of the medium that are printed, e.g. the width of the print job, full scan signalling, skip signalling for white space, etc. This way, the power consumption is further reduced be restricting the coating exactly to the printed portions that require protection. The signalling may further be indicative for the speed of the print head, the print step, and other parameters of the printing device.

Optionally, as defined by claim 9, the printing and coating apparatus according to the present invention may comprise a carriage, movably mounted on a bridge, for carrying the inline drying device, the inline coating device and the second inline drying device.

Thus, as already explained above, by rigidly mounting the drying device(s) and coating device on a single carriage, the drying and coating can both be restricted to portions of the medium that are printed. This way the power consumption for the drying and coating steps is minimized.

As is indicated by claim 10, the apparatus according to the current invention may comprise a coating cartridge, connected to the inline coating device.

Indeed, as an alternative to an external container connected to the coating device via a coating material supply pipe, the coating material may be kept in a coating cartridge that fits in a particular portion of the apparatus according to the present invention and that is easily replaceable by the end-user of the apparatus.

Again optionally, as defined by claim 11, the inline coating device in the apparatus according to the present invention may comprise a Rayleigh breakup spray head.

As opposed to a regular spray head, such Rayleigh breakup spray head avoids uncontrolled spraying of drops of the coating material.

The current invention further relates to a process for coating and printing a medium as defined by claim 12, comprising the steps of:
a. drying the medium to thereby generate a dried medium;
b. inline coating the dried medium to thereby generate a coated medium;
c. inline drying the coated medium to thereby generate a dried coated medium; and
d. printing an image on the dried coated medium to thereby generate a printed coated medium, whereby the drying in step a, the inline coating in step b and the inline drying in step c are executed in synchronism with the printing in step d.

The present invention in addition also relates to a corresponding apparatus as defined by claim 13, comprising:
a. a drying device for drying a medium to thereby generate a dried medium;
b. a coating device for inline coating the dried medium to thereby generate a coated medium;
c. a second drying device for inline drying the coated medium to thereby generate a dried coated medium; and
d. a printing device for printing an image on the dried coated medium to thereby generate a printed coated medium, whereby the drying device, the coating device and the second drying device are adapted to operate in synchronism with the printing device.

### BRIEF DESCRIPTION OF THE DRAWINGS

FIG. 1 illustrates an embodiment of the apparatus for printing and coating according to the present invention;

FIG. 2 is a top view of the coating and drying portion that forms part of the embodiment of the current invention drawn in FIG. 1; and

FIG. 3 is a side view of the coating and drying portion that forms part of the embodiment of the current invention drawn in FIG. 1.

### DETAILED DESCRIPTION OF EMBODIMENT(S)

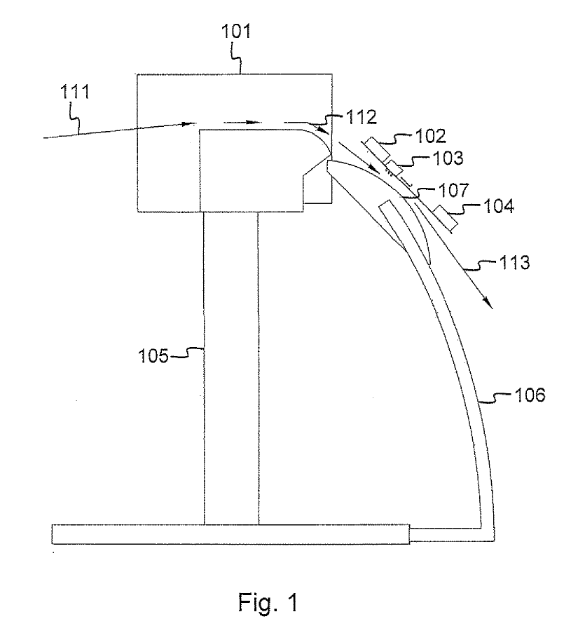

The printing and coating apparatus drawn in FIG. 1 contains a printing portion or printing device 101 on a vertical support 105, and a coating portion on a second support 106. Support 105 and support 106 may be integrated into a single stand or may be connected as depicted in FIG. 1. The coating portion comprises a first drying device 102, a coating device 103 and a second drying device 104, as well as a heated surface 107 for conveying the medium.

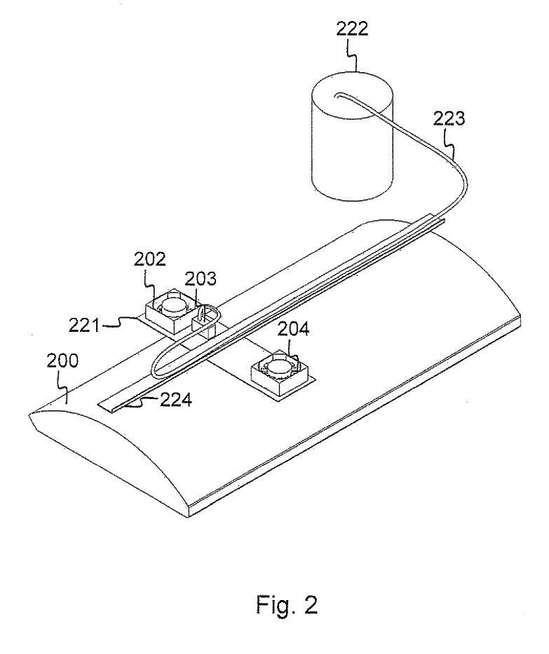

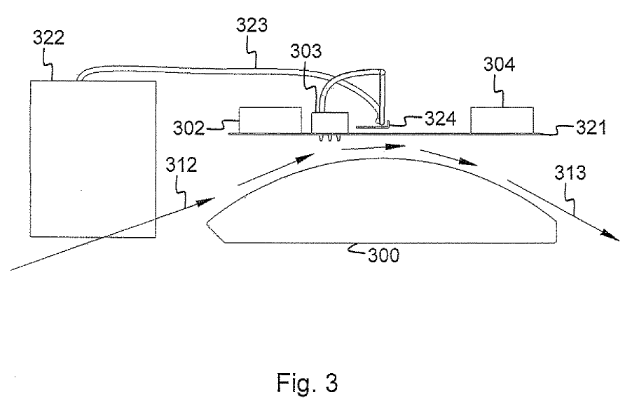

The printing device 101 in FIG. 1 is supposed to be an ink jet printing device able to digitally print an image on a substrate or medium 111 by discharging ink from an ink jet recording head onto the medium 111. The medium 111 to be printed can be paper, photo paper, a poster, a transparency, a t-shirt, etc. The image can be a picture, a graph, a text, a photo, an artwork, etc. or a combination thereof. The printing device 101 contains a sensor, not drawn in FIG. 1, to detect the leading edge of the medium 111 and a drive mechanism to advance the medium 111 through the printing and coating apparatus, such as for instance one or more rollers driven by a step motor. The printed medium is referenced by 112 in FIG. 1 and fed automatically into the coating portion of the apparatus that will be described in detail in the following paragraphs referring to FIG. 2 and FIG. 3. The apparatus in FIG. 1 at last outputs a coated printed medium 113.

FIG. 2 shows the first drying device 102, coating device 103 and second drying device 104 in more detail. The first drying device is constituted by a relatively small ventilator 202. The coating device consists of a Rayleigh breakup spray head or a piezo actuated print head or a print head with electro-mechanical actuation 203 connected via a coating material supply conduct 223 to a coating material reservoir that is kept under pressure. The second drying device 204 is also constituted by a relatively small ventilator 204, similar to the first one. The first ventilator 202, the coating spray head 203 and the second ventilator 204 are rigidly mounted on a single carriage 221 that is laterally moveable along a bridge 224. This way, the coating spray head 203 and the ventilators 202 and 204 can reach different sections on the printed medium. FIG. 2 in addition shows the heated surface 200 (corresponding to reference 107 in FIG. 1) over which the printed medium 112 is progressively advanced in order to get dried and coated.

FIG. 3 at last shows a side view of the drying and coating portion of the printing apparatus of FIG. 1, the arrows indicating the path followed by the printed medium 312 along the heated surface 300. The first drying device or ventilator is referenced by 302 in FIG. 3, the coating spray head is referenced by 303, and the second drying device or ventilator is referenced by 304 in FIG. 3. These three devices are mounted on carriage 321 which can slide along the bridge 324. FIG. 3 further shows the coating material container 322 and the coating material supply pipe 323 that connects an outlet of the container 322 to an inlet of the coating spray head 303. The heated surface 300 corresponds to reference 107 in FIGS. 1 and 200 in FIG. 2. The coated printed medium 313 (corresponding to 113 in FIG. 1) leaves the apparatus via a slot in between the heated surface 300 and the second ventilator 304, eventually to be collected in a tray not shown in any of the figures. The heated surface is depicted as convex, but it may be flat or concave, depending on the integration with the printing equipment.

The process executed by the printing and coating apparatus illustrated by FIG. 1, FIG. 2 and FIG. 3 will now be described. Upon instruction of software or instruction of the end-user, an image will be printed on a medium 111 and the medium shall be coated. Thereto, the medium 111 is sensed and guided into the printing device 101 where an ink jet print head prints the image on the medium. The printed medium 112 or the portion of the medium that has been printed is advanced into the second part of the apparatus where the ventilator 102, coating device 103 and second ventilator 104 reside. In this second part, the ink on the printed medium 112 is partially dried by sliding the medium 112 along heated surface 107, partially dried by air-ventilating the space in between the sliding printed medium 112 and ventilator 102. The portions of the printed medium 112 whereon the image has been printed are coated with a varnish spray evenly distributed by the coating spray head that forms part of coating device 103. A sensor, not drawn in the figures, senses when the print head in 101 starts moving to print a line of the image. The sensor flags this moment to the coating device 103, which thereupon starts coating a line or lateral section on the printed medium 112. The coating device 103 is preconfigured to know the speed of the print head and the width of the print job and is controlled to stop applying the coating material before the print head reaches the end of the line. This way, it is avoided that coating material is sprayed over portions of the printed medium 112 while the medium is moved forward by the drive mechanism in printing device 101. The ventilator 102 moves laterally together with the coating device 103 and consequently dries the ink only in a zone that will be coated soon, during the next passage of the coating device 103. Post-drying, i.e. drying of the coating material on the coated printed medium 113 is done by ventilator 104 which also moves laterally together with the coating device 103 and which consequently only dries areas on the printed medium 113 that have been coated recently, i.e. in a previous passage of the coating device 103. The coated printed medium 113 leaves the apparatus through an exit slot in between the heated surface 107 and the second ventilator 104.

In a variant embodiment of the apparatus according to the present invention, the drive mechanism advancing the medium may be integrated in the second part of the apparatus, i.e. the part where also the drying and coating devices reside. In such embodiment, a sensor may have to be foreseen which backwards signals advancement of the medium towards the printing apparatus in order to ensure that the printing of the image is interrupted each time the medium is moved forward. In another variant embodiment of the current invention, both the printing part and the coating part of the apparatus may be equipped with a drive mechanism to independently advance the medium. In such embodiment, a buffer in between the printing part and coating part can prevent rupturing the medium, or the two drive mechanisms may be controlled or operationally coupled in order to avoid rupturing the medium.

As an alternative to the sensor described above in relation to the embodiment of the current invention where movement of the print head is sensed and flagged to the coating device, or to the sensor reverse signalling advancement of the medium in the embodiment of the previous paragraph, the printing device and coating device may be interfacing electronically to signal movement of the print head. In case such interface is foreseen, the signalling interchanged may be enhanced to be indicative for printer, medium or image related parameters such as the width of the print job or maximum width of the coating job, the medium quality and size (e.g. paper thickness and size), the print head speed, the step of the printing device. In another alternative embodiment of the invention, such parameters may be manually configurable by the user of the apparatus through a touch screen, keypad, or other user interface integrated with the apparatus, or the parameters may be software configurable via a PC (Personal Computer) connection.

Although FIG. 2 and FIG. 3 show a container wherein the coating material is kept under pressure, the coating material could alternatively be kept under pressure in a replaceable cartridge that is for instance mounted on the coating spray head. Such cartridge would have an interface with nozzles enabling the coating material to reach the spray head. The nozzles and material of the printing cartridge containing the coating material would be designed depending on the constitution of the coating material.

Instead of the ventilators deployed in the above described embodiment, the drying and post-drying can be achieved through variant drying techniques, such as UV (ultra-violet) drying, hot air drying, radiation, heated surface drying, etc., and/or combinations of these techniques. Post-drying may be enhanced through accurate selection of the coating material constituents and/or through curing techniques.

Variant embodiments of the apparatus according to the present invention may not include the second ventilator or alternate post-drying mechanisms, i.e. natural post-drying may be relied upon. In still other embodiments of the invention, the drying in between printing and coating and the post-drying may be separately configurable, and the drying means need not necessarily be mounted on one and the same carriage.

Further, the apparatus according to the present invention may be employed with the coating device ahead of the printing device, such that the medium can receive a primer before being printed. The medium can be dried before the primer is sprayed onto portions of the medium where an image will be printed. The portions of the medium that have received the primer are thereafter dried before the image is printed. In a more advanced embodiment which is able to treat the medium with a primer and to protect the printed images with a coating layer, the printed medium may be dried after the image has been printed, coated and post-dried similarly as in the embodiment described above with reference to the drawings, such that the image printed on the primer-treated medium is further protected through a top coating layer.

Although the present invention has been illustrated by reference to specific embodiments, it will be apparent to those skilled in the art that the invention is not limited to the details of the foregoing illustrative embodiments, and that the present invention may be embodied with various changes and modifications without departing from the spirit and scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the spirit and scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfill the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order.

1. A process for printing and coating of a medium,
said process comprising the steps of:
a. printing an image on said medium, thereby generating a printed medium;
b. inline drying said printed medium in synchronism with said printing in step a, thereby generating a dried printed medium; and
c. inline coating said dried printed medium in synchronism with said printing in step a, thereby generating a coated printed medium.

2. The process according to claim 1,
process further comprising the step of:
d. inline drying said coated printed medium in synchronism with said printing in step a.

3. The process according to claim 1 or claim 2,
wherein said drying in step b and/or said drying in step d are executed only on portions of said medium that are coated in said step c.

4. The process according to claim 1 or claim 2,
wherein said drying in step b and/or said drying in step d involve ventilation and/or heated surfacing.

5. The process according to claim 1,
wherein said inline coating in step c is synchronized with said printing in step a through signalling received from said printing process in step a.

6. The process according to claim 1,
wherein said inline coating in step c is executed on portions of said medium identified by signalling received from said printing process in step a.

7. An apparatus for printing and coating of a medium,
said apparatus comprising:
a. a printing device arranged to print an image on said medium to thereby generate a printed medium;
b. a first inline drying device arranged to dry at least portions of said printed medium to thereby generate a dried printed medium, said first inline drying device being adapted to operate in synchronism with said printing device; and
c. an inline coating device arranged to coat at least portions of said dried printed medium to thereby generate a coated printed medium, said first inline coating device being adapted to operate in synchronism with said printing device.

8. The apparatus according to claim 7,
wherein said apparatus further comprises:
d. a second inline drying device arranged to dry at least portions of said coated printed medium, said second in line drying device being adapted to operate in synchronism with said printing device.

9. The apparatus according to claim 8,
wherein said apparatus comprises a carriage, movably mounted on a bridge, arranged to carry said first inline drying device, said inline coating device and said second inline drying device.

10. The apparatus according to claim 7,
wherein said apparatus further comprises a coating cartridge, connected to said first inline coating device.

11. The apparatus according to claim 7,
wherein said first inline coating device comprises a Rayleigh breakup spray head.

12. A process for coating and printing a medium,
said process comprising the steps of:
a. drying said medium to thereby generate a dried medium;
b. inline coating said dried medium to thereby generate a coated medium;
c. inline drying said coated medium to thereby generate a dried coated medium; and
d. printing an image on said coated medium to thereby generate a printed coated medium, whereby said drying in step a, said inline coating in step b and said inline drying in step c are executed in synchronism with said printing in step d.

13. An apparatus for coating and printing of a medium,
said apparatus comprising:
a. a first drying device arranged to dry said medium to thereby generate a dried medium;
b. a coating device arranged to inline coat said dried medium to thereby generate a coated medium;
c. a second drying device arranged to for inline dry said coated medium to thereby generate a dried coated medium; and
d. a printing device arranged to print an image on said dried coated medium to thereby generate a printed coated medium, wherein said first drying device, said coating device and said second drying device are adapted to operate in synchronism with said printing device.
